(19) United States
(12) Patent Application Publication
(10) Pub. No.: US 2011/0010738 A1
(43) Pub. Date: Jan. 13, 2011

(54) SYSTEM AND METHOD FOR SELECTION OF TELEVISION CONTENT USING TAB-BASED SELECTION FEATURES

(75) Inventors: Eric Stephen Carlsgaard, Zionsville, IN (US); Mark Gilmore Mears, Zionsville, IN (US); James Duane Tenbarge, Fishers, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD., Shekou, Shenzhen, Guangdong (CN)

(21) Appl. No.: 12/919,357

(22) PCT Filed: Apr. 25, 2008
(86) PCT No.: PCT/US08/61636

§ 371 Date: Aug. 25, 2010

(30) Foreign Application Priority Data
Mar. 18, 2008 (CN) 200810066107.0

(51) Int. Cl. H04N 5/445

(52) U.S. Cl. 725/37

(57) ABSTRACT

There is provided a system and method for selection of television content. More specifically, in one embodiment, there is provided an electronic device, comprising a processor that is adapted to receive video data from a plurality of source types and to create an on-screen content selection interface on a display, the on-screen content selection interface including a graphical tab corresponding to each of the plurality of source types of video data.

### FIELD OF THE INVENTION

The present invention relates generally to a user interface for an electronic device. In particular, an exemplary embodiment of the present invention relates to a system and method for finding and selecting content, programs, channels, and inputs.

### BACKGROUND OF THE INVENTION

This section is intended to introduce the reader to various aspects of art, which may be related to various aspects of embodiments of the present invention that are described and/or claimed below. This discussion is believed to be helpful in providing the reader with background information to facilitate a better understanding of the various aspects of embodiments of the present invention. Accordingly, it should be understood that these statements are to be read in this light, and not as admissions of prior art.

A wide variety of media content may be accessible to a user via currently available televisions. For example, currently available digital televisions may provide access to digital television channels, analog television channels, antenna channels, cable channels, and inputs from other devices (e.g., DVD players, CD players, hard disk drives, and memory cards). Currently available televisions can also display or present content from media types not traditionally associated with television, such as digital pictures and computer files, which may be accessed from a hard disk drive, a home network, or the like.

While a wide variety of content is available from numerous different sources, existing televisions generally only present media from a few sources. Indeed, many televisions are configured to only present media from a single selected source. Accordingly, a user is required to select specific content for presentation from the available media. Existing techniques for selecting media include entering a channel number with number keys, channeling up or down with scrolling keys, or selecting soft buttons in a content specific graphical menu.

Traditional television systems typically provide different interface formats for different types of media input. In other words, there are typically variations in the media selection process for presentation on a television based on a type of media being selected. For example, the processes for selecting input from a DVD player, a cable provider, and a hard disk drive all typically differ. In a specific example, a cable television input may require the viewer to use channel up and down buttons to make a selection, whereas viewing digital pictures may require the viewer to scroll through a menu of digital images using a directional pad. Such differences in selection or navigation format can make media selection frustrating and inefficient for a user.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a diagram of a screen of a television display including a tab-based menu in accordance with an exemplary embodiment of the present invention;

FIG. 3 is a diagram of a screen of a television display including a tab-based menu in accordance with an exemplary embodiment of the present invention;

FIG. 4 is a diagram of a screen of a television display including a tab-based menu in accordance with an exemplary embodiment of the present invention;

FIG. 5 is a diagram of a screen of a television display including a tab-based menu in accordance with an exemplary embodiment of the present invention;

FIG. 6 is a diagram of a screen of a television display including a tab-based menu in accordance with an exemplary embodiment of the present invention; and

FIG. 7 is a block diagram of a method in accordance with an embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

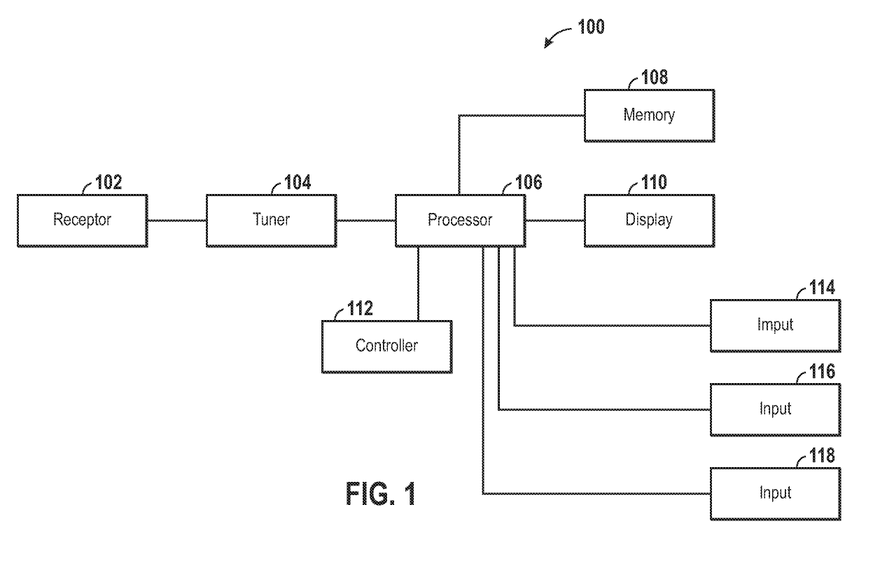

FIG. 1 is a block diagram of an electronic device in accordance with an exemplary embodiment of the present invention. The electronic device (e.g., a television, set top box, or computer system) is generally indicated by the reference number 100. The electronic device 100 (for example, a television, a set top box or the like) comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

The electronic device 100 comprises at least one receptor 102 (e.g., a cable inlet, device inlet, or an antenna), a tuner 104, a processor 106, a memory 108, a display 110, a controller 112 (e.g., remote control), and various peripheral inputs 114, 116, and 118. The memory 108 may comprise a tangible machine-readable medium adapted to hold machine-readable computer code that causes the processor 106 to perform an exemplary method in accordance with present embodiments. For example, the memory 108 and the processor 106 may cooperate to operate as a control system that provides an on-screen selection interface in accordance with present embodiments.

Embodiments of the present invention are directed to a system and method for displaying uniform menus for diverse types of media on a television. More specifically, in accordance with present embodiments, there is provided a tab-based menu system that displays a plurality of selectable tabs that may be described as graphic images that appear to overlap one another. For example, in one embodiment, this tab-based menu system includes a user interface (UI) that employs a graphical representation of available inputs, media categories, and channels by displaying separate, overlapping columns or tabs that are readily navigable for rapid and accurate content selection. This UI or on-screen selection interface may be referred to as a tab-based content source selection system (TCSSS). Each tab has a similar appearance and the user may choose a tab corresponding to a particular data input type. Further, a user may create a custom tab that includes multiple types of media content on a single tab in accordance with present embodiments.

It should be noted that navigation of the tab-based menu system may be facilitated by employing an advanced remote control device including a scroll wheel, joystick, motion-based pointer, or the like. However, a standard remote control may be utilized as well. An interpreted “content” command from a remote control may initiate or activate the TCSSS on a television. For example, in one embodiment an upward movement of a directional pad on the controller 112 (e.g., a remote control) when there is no active menu may be interpreted as the “content” command. In other embodiments, a specific button on the controller 112 may be assigned to initiate the “content” command.

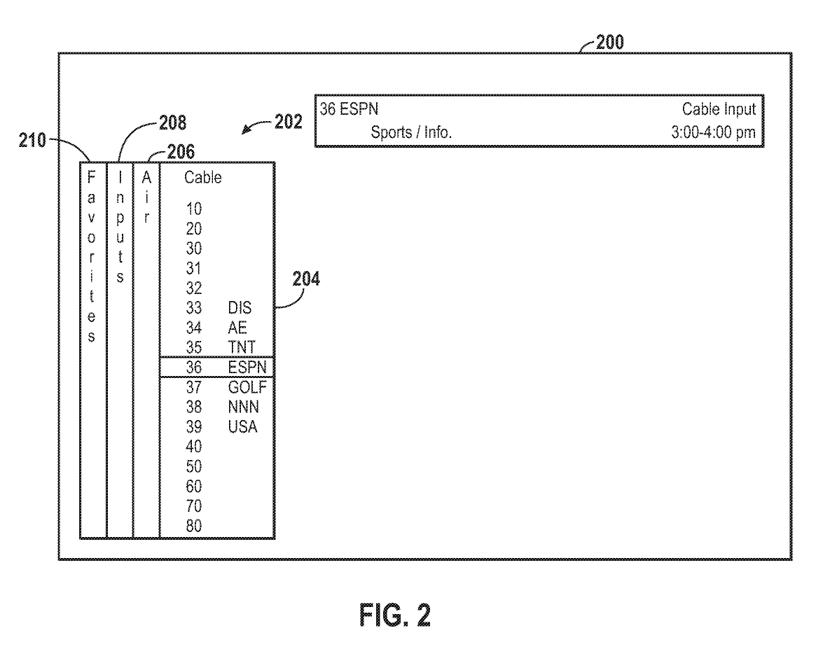

The TCSSS may provide several graphic items that appear to be overlapping graphical shapes (e.g., columns or tabs) on the television display 110. For example, FIG. 2 illustrates a screen 200 of a television display (e.g., the display 110) that includes a menu 202 positioned on an edge of the display. The menu 202 includes four overlapping columns in accordance with present embodiments. A top graphical shape (i.e., the graphical shape that appears to be on top of the other graphical shapes) is active and the others are inactive. For example, the four columns of the menu 202 in FIG. 2 include a first column 204 that is active and displaying available cable channels. The inactive graphical shapes of the menu 202 include a second column 206 that is configured to display air channels when active, a third column 208 that is configured to display input channels when active, and a fourth column 210 that is configured to display user-selected channels or “favorites” when active. As illustrated in FIG. 2, the inactive graphical shapes are mostly hidden, with only a “tab” having a label for identifying their content being visible.

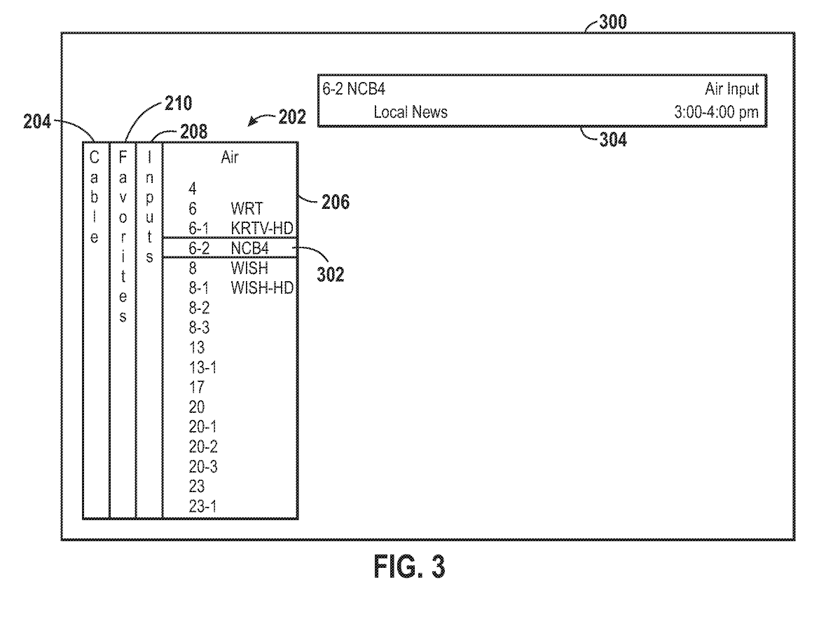

Each of the graphical shapes of the TCSSS may be selected such that the selected graphical shape is activated. Once activated, the selected graphical shape becomes the top graphical shape and the content or options associated with the graphical shape may become available for selection. For example, in FIG. 2, a user may navigate from the active first column 204 to one of the other columns by positioning a cursor over a tab of one of the inactive columns 206, 208, or 210 or cycling through the tabs by activating a feature of a controller (e.g., a joystick or directional pad of the controller 112). Specifically, in accordance with the embodiment illustrated in FIG. 2, a user could activate the second column 206 by moving a selector to the left away from the first column 204. Upon selection of the second column 206, a screen 300 will be presented wherein the menu 202 is revised such that the second column 206 is on top and its contents are actively selectable, as illustrated in FIG. 3. Further, the TCSSS may be exited by moving the selector to the right or away from the inactive columns.

When the TCSSS is open, a user may navigate the available features of the active column and select desired features. For example, in one embodiment, a user can send an “upward movement” or “downward movement” command to highlight various channels from the active column. This may be a step-by-step process or an accelerated process that allows a user to move through options more rapidly than one option at a time. For example, holding a remote control feature in a particular direction for a designated period of time may accelerate movement through the options. Additionally, to facilitate selection, channels displayed in the active column may be kept to a minimum of the presently selected channel and those that are nearby. Other channels that are not nearby may simply be designated as a line or dash. For example, a horizontal line may be displayed for every 10 channels for antenna channels and every 100 channels for cable channels.

When a column or tab is active, the content associated with the active tab may be selected for viewing by highlighting the content of interest and then activating it. For example, as illustrated in FIG. 3, the column 206 is active and displaying available air channels. Further, as illustrated in FIG. 3, a channel 302 is highlighted. The highlighted channel may be selected for presentation by activating an “enter” command (e.g., pressing a particular button on a remote control). Once a channel is selected and activated, the media associated with the highlighted channel will be presented via the television. For example, a tuning process may be initiated for the selected channel.

When a particular column is active, an information bar 304 may also become active. The information bar 304 may include specific information about the highlighted or selected channel. For example, the information bar 304 may display the channel number, channel name, local affiliate, closed captioning status, aspect ratio, audio options, and input source for the channel 302. Other information may also be displayed. For example, the information bar 304 may include information about the programming available on the channel 302, such as start time, rating, a brief description of available programs, and so forth. This information may be available from a guide service, a cableCARD or from a digital data stream. Further, this information may help the user decide whether to select a channel for presentation.

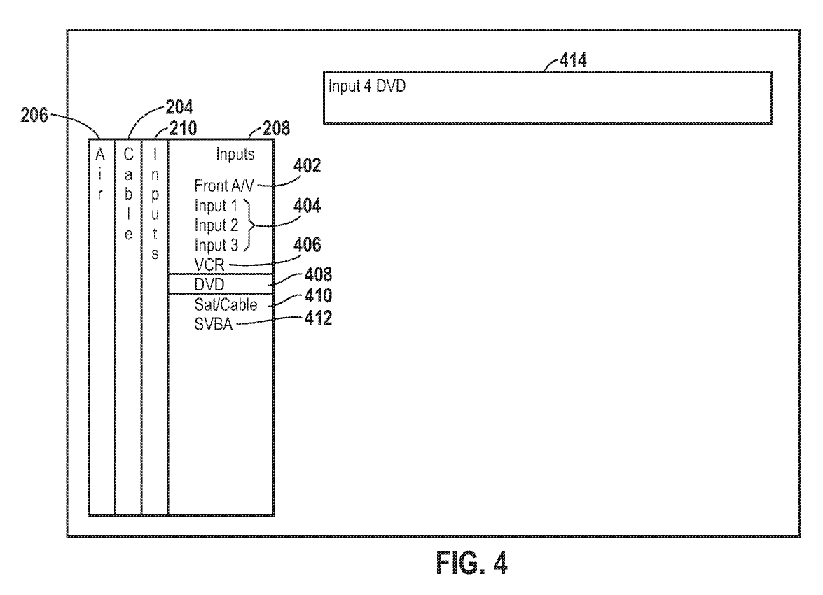

FIG. 4 is an illustration of the TCSSS when the third column 208 is active. As set forth above, the third column 208 displays available input channels when it is active. Input channels include signals from peripheral devices. For example, in the illustrated embodiment, the input channels include Front NV 402 (i.e., input from the front audio/video jacks on the television), Inputs 404 (i.e., input from any current or future media source communicatively coupled to input terminals on the television), VCR 406 (i.e., input from a video cassette recorder), DVD 408 (i.e., input from a digital versatile disc player), SAT/Cable 410 (i.e., input from a satellite or cable transmission), HDMI 410 (i.e., input from a high definition multimedia interface), and SVGA 412 (i.e., input from a personal computer). In the illustrated embodiment, the DVD 408 is highlighted and the information bar 414 is displaying information regarding the highlighted channel.

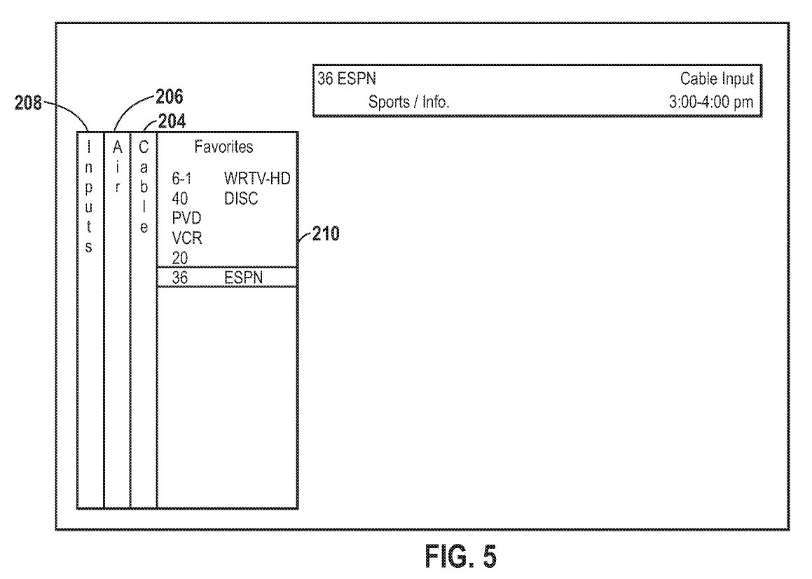

FIG. 5 is an illustration of the TCSSS when the fourth column 210 is active. As set forth above, the fourth column 210 displays user-selected channels referred to as “favorites” when it is active. The fourth column 210 of the illustrated embodiment enables users to define it to include any source of input and any channel on a single menu tab. This will enable a user to conveniently switch between favorite channels and favorite sources of input within a single menu tab or column.

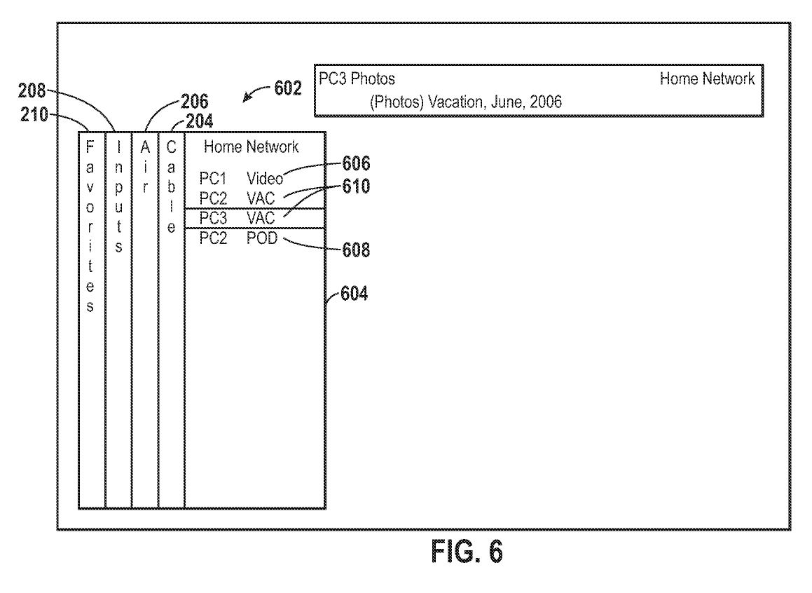

Embodiments of the present technique may include various different types of tabs or columns. For example, FIG. 6 is an illustration of the TCSSS with a menu 602 including a home network tab 604 that is active. The home network tab 604 may be available when a television is in communication with a network (e.g., a home computer network). The home network tab 604 may facilitate access to content that is available over the network, such as photos, video, music and so forth that may be stored on network computers or drives. It should be noted that text colors may be utilized in accordance with present embodiments to distinguish content. For example, in FIG. 6, white font may be utilized to designate video content 606, green font may be used for music content 608, and red font may be used for photographs 610.

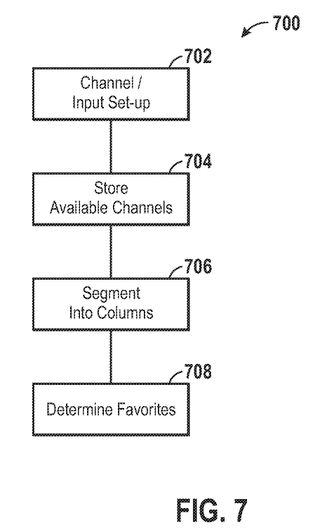

FIG. 7 is a block diagram representing a method in accordance with present embodiments. The method is generally indicated by reference numeral 700. While the method 700 includes specific steps, it should be noted that it is merely representative of particular embodiments. In some embodiments, certain steps may be added and others may not be included.

The method 700 begins with a full channel/input set-up process, as represented by block 702. Block 702 may be performed during an initial turn-on process of the television. For example, once the television is set up, the full channel/input set-up process of block 702 may be performed the first time the television is turned on. When additional channels become available, the process may be repeated. The process of block 702 may include analog, digital, antennae, cable, and input channel scanning. Further, block 702 may include input label selection options (e.g., DVD or VCR).

Once the available channels and inputs are identified by the process of block 702, the related information may be stored in a memory as selection options, as illustrated by block 704. This may include storing the information on a flash memory or a semi-permanent memory that will be available to the TCSSS for program selection. The selection options are then segmented into tabbed columns based on channel type (e.g., antenna, cable, and inputs), as illustrated by block 706. The antenna and cable columns may be defined to include both analog and digital channels, which may be differentiated by background, font style, font color, or the like to facilitate identification by a user.

Block 708 represents determining favorite channels for association with a “favorites tab,” such as the fourth column 210. Favorite channels may be determined with various different techniques and present embodiments may utilize the results of any of the various techniques.

For example, a user may explicitly designate specific channels (e.g., cable channels or device inputs) or the channels may automatically be designated based on the number of times a user accesses the channels. It should be noted that the favorite channels include both selected channels and inputs and that they are grouped together in a separate tab or column to facilitate access. The channels that are designated as favorites may be illustrated with a distinct style in every column in which they appear. For example, in a cable column (e.g., the first column 204), analog channel options may be presented with standard font, digital channels may be presented with bold font, and while regular channels are in black, the favorites may be in yellow.

While the invention may be susceptible to various modifications and alternative forms, specific embodiments have been shown by way of example in the drawings and will be described in detail herein.

However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An electronic device, comprising:
a processor that is adapted to receive video data from a plurality of source types and to create an on-screen content selection interface on a display, the on-screen content selection interface including a graphical tab corresponding to each of the plurality of source types of video data.

2. The electronic device of claim 1, wherein the plurality of source types include a source of over the air television channels.

3. The electronic device of claim 1, wherein the plurality of source types include a source of cable television channels.

4. The electronic device of claim 1, wherein the plurality of source types include a computer interface.

5. The electronic device of claim 1, wherein the plurality of source types include peripheral media devices, an antenna, and a cable.

6. The electronic device of claim 1, wherein the on-screen content selection interface comprises a graphical tab corresponding to user-selected channels.

7. The electronic device of claim 1, wherein a one of the graphical tabs displays a list of a plurality of selectable channels including analog and digital channels.

8. The electronic device of claim 7, wherein each of the selectable channels is displayed in a font corresponding to a type of each of the selectable channels.

9. The electronic device of claim 8, wherein analog channels are displayed in a red font.

10. The electronic device of claim 7, wherein the selectable channels include input channels.

11. The electronic device of claim 1, wherein a one of the graphical tabs displays a list of a plurality of selectable input channels including input from a computer interface.

12. The electronic device of claim 1, wherein the on-screen content selection interface is configured to be initiated by activation of a control feature of a controller in a particular direction when no menu is actively being displayed on the display.

13. The electronic device of claim 1, wherein the electronic device comprises a television, a set top box, or a computer system.

14. A method of operation of a television, the method comprising:
receiving video data from a plurality of source types; and
displaying an on-screen content selection interface, the on-screen content selection interface including a graphical tab corresponding to each of the plurality of source types of video data.

15. The method of claim 14, comprising displaying a list of selectable options in a one of the graphical tabs that is active.

16. The method of claim 15, wherein the selectable options in the list of selectable options are each displayed in a font corresponding to source type for each option.

17. The method of claim 14, comprising displaying an active tab on top of inactive tabs.

18. The method of claim 14, comprising initiating the on-screen content selection interface upon receiving a move upward command from a controller when no menus are actively being displayed.

19. The method of claim 14, comprising compiling a favorites menu based on user input.

20. An electronic device, comprising:
means for receiving video data from a plurality of source types;
and means for providing an on-screen content selection interface, the on-screen content selection interface including a graphical tab corresponding to each of the plurality of source types of video data.
